(19) United States
(12) Patent Application Publication
(10) Pub. No.: US 2015/0074222 A1
(43) Pub. Date: Mar. 12, 2015

(54) METHOD AND APPARATUS FOR LOAD BALANCING AND DYNAMIC SCALING FOR LOW DELAY TWO-TIER DISTRIBUTED CACHE STORAGE SYSTEM

(71) Applicants: Guanfeng Liang, Sunnyvale, CA (US); Ulas C. Kozat, Santa Clara, CA (US); Chris Xiao Cai, Champaign, IL (US)

(72) Inventors: Guanfeng Liang, Sunnyvale, CA (US); Ulas C. Kozat, Santa Clara, CA (US); Chris Xiao Cai, Champaign, IL (US)

(21) Appl. No.: 14/473,815

(22) Filed: Aug. 29, 2014

Related U.S. Application Data
(60) Provisional application No. 61/877,158, filed on Sep. 12, 2013.

(51) Int. Cl. H04L 29/08; G06F 12/08

(52) U.S. Cl. CPC H04L 67/2842; G06F 12/0891; G06F 2212/154
USPC 709/214

(57) ABSTRACT

A method and apparatus is disclosed herein for load balancing and dynamic scaling for a storage system. In one embodiment, an apparatus comprises a load balancer to direct read requests for objects, received from one or more clients, to at least one of one or more cache nodes based on a global ranking of objects, where each cache node serves the object to a requesting client from its local storage in response to a cache hit or downloads the object from the persistent storage and serves the object to the requesting client in response to a cache miss, and a cache scaler communicably coupled to the load balancer to periodically adjust a number of cache nodes that are active in a cache tier based on performance statistics measured by one or more cache nodes in the cache tier.

### PRIORITY

The present patent application claims priority to and incorporates by reference the corresponding provisional patent application Ser. No. 61/877,158, titled, “A Method and Apparatus for Load Balancing and Dynamic Scaling for Low Delay Two-Tier Distributed Cache Storage System,” filed on Sep. 12, 2013.

### FIELD OF THE INVENTION

Embodiments of the present invention relate to the field of distributed storage systems; more particularly, embodiments of the present invention relate to load balancing and cache scaling in a two-tiered distributed cache storage system.

### BACKGROUND OF THE INVENTION

Cloud hosted data storage and content provider services are in prevalent use today. Public clouds are attractive to service providers because the service providers get access to a low risk infrastructure in which more resources can be leased or released (i.e., the service infrastructure is scaled up or down, respectively) as needed.

One type of cloud hosted data storage is commonly referred to as a two-tier cloud storage system. Two-tier cloud storage systems include a first tier consisting of a distributed cache composed of leased resources from a computing cloud (e.g., Amazon EC2) and the second tier consisting of a persistent distributed storage (e.g., Amazon S3). The leased resources are often virtual machines (VMs) leased from a cloud provider to serve the client requests in a load balanced fashion and also provide a caching layer for the requested content.

Due to pricing and performance differences in using publically available clouds, in many situations multiple services from the same or different cloud providers must be combined. For instance, storing objects is much cheaper in Amazon S3 than storing those objects in a memory (e.g., a hard disk) of a virtual machine leased from Amazon EC2. On the other hand, one can serve end users faster and in a more predictable fashion on an EC2 instance with the object locally cached albeit at a higher price.

Problems associated with load balancing and scaling for the cache tier exist in the use of two-tier cloud storage systems. More specifically, one problem being faced is how should the load balancing and scale up/down decisions for the cache tier be performed in order to achieve high utilization and good delay performance. For scaling up/down decisions, there is a problem of how to adjust the number of resources (e.g., VMs) in response to dynamics in workload and changes in popularity distributions is a critical issue.

Load balancing and caching policies are prolific in the prior art. In one prior art solution involving a network of servers, where the servers can locally serve the jobs or forward the jobs to another server, the average response time is reduced and the load each server should receive is found using a convex optimization. Other solutions for the same problem exist. However, these solutions cannot handle system dynamics such as time-varying workloads, number of servers, service rates. Furthermore, the prior art solutions do not capture data locality and impact of load balancing decisions on current and (due to caching) future service rates.

Load balancing and caching policy solutions have been proposed for P2P (peer-to-peer) file systems. One such solution involved replicating files proportional to their popularity, but the regime is not storage capacity limited, i.e., aggregate storage capacity is much larger than the total size of the files. Due to the P2P nature, there is no control over the number of peers in the system as well. In another P2P system solution, namely a video-on-demand system with each peer having a connection capacity as well as storage capacity, content caching strategies are evaluated in order to minimize the rejection ratios of new video requests.

Cooperative caching in file systems has also been discussed in the past. For example, there has been work on centrally coordinated caching with a global least recently used (LRU) list and a master server dictating which server should be caching what.

Most P2P storage systems and noSQL databases are designed with dynamic addition and removal of storage nodes in mind. Architectures exist that rely on CPU utilization levels of existing storage nodes to add or terminate storage nodes. Some have proposed solutions for data migration between overloaded and underloaded storage nodes as well as adding/removing storage nodes.

### SUMMARY OF THE INVENTION

A method and apparatus is disclosed herein for load balancing and dynamic scaling for a storage system. In one embodiment, an apparatus comprises a load balancer to direct read requests for objects, received from one or more clients, to at least one of one or more cache nodes based on a global ranking of objects, where each cache node serves the object to a requesting client from its local storage in response to a cache hit or downloads the object from the persistent storage and serves the object to the requesting client in response to a cache miss, and a cache scaler communicably coupled to the load balancer to periodically adjust a number of cache nodes that are active in a cache tier based on performance statistics measured by one or more cache nodes in the cache tier.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of one embodiment of a system architecture for a two-tier storage system.

FIG. 2 is a block diagram illustrating an application for performing storage in one embodiment of a two-tier storage system.

FIG. 3 is a flow diagram of one embodiment of a load balancing process.

FIG. 4 is a flow diagram of one embodiment of a cache scaling process.

FIG. 5 illustrates one embodiment of a state machine for a cache scaler.

FIG. 6 illustrates pseudo-code depicting operations performed by one embodiment of a cache scaler.

FIG. 7 depicts a block diagram of one embodiment of a system.

FIG. 8 illustrates a set of code (e.g., programs) and data that is stored in memory of one embodiment of the system of FIG. 7.

### DETAILED DESCRIPTION OF THE PRESENT INVENTION

Embodiments of the invention include methods and apparatus for load balancing and auto-scaling that can get the best delay performance while attaining high utilization in two-tier cloud storage systems. In one embodiment, the first tier comprises a distributed cache and the second tier comprises persistent distributed storage. The distributed cache may include leased resources from a computing cloud (e.g., Amazon EC2), while the persistent distributed storage may include leased resources (e.g., Amazon S3).

In one embodiment, the storage system includes a load balancer. For a given set of cache nodes (e.g., servers, virtual machines (VMs), etc.) in the distributed cache tier, the load balancer evenly distributes, to the extent possible, the load against workloads with an unknown object popularity distribution while keeping the overall cache hit ratios close to the maximum.

In one embodiment, the distributed cache of the caching tier includes multiple cache servers and the storage system includes a cache scaler. At any point in time, techniques described herein dynamically determine the number of cache servers that should be active in the storage system, taking into account of the facts that object popularities of objects served by the storage system and the service rate of persistent storage are subject to change. In one embodiment, the cache scaler uses statistics such as, for example, request backlogs, delay performance and cache hit ratio, etc., collected in the caching tier to determine the number of active cache servers to be used in the cache tier in the next (or future) time period.

In one embodiment, the techniques described herein provide robust delay-cost tradeoff for reading objects stored in two-tier distributed cache storage systems. In the caching tier that interfaces to clients trying to access the storage system, the caching layer for requested content comprises virtual machines (VMs) leased from a cloud provider (e.g., Amazon EC2) and the VMs serve the client requests. In the backend persistent distributed storage tier, a durable and highly available object storage service such as, for example, Amazon S3, is utilized. At light workload scenarios, a smaller number of VMs in the caching layer is sufficient to provide low delay for read requests. At heavy workload scenarios, a larger number of VMs is needed in order to maintain good delay performance. The load balancer distributes requests to different VMs in a load balanced fashion while keeping the total cache hit ratio high, while the cache scaler adapts the number of VMs to achieve good delay performance with a minimum number of VMs, thereby optimizing, or potentially minimizing, the cost for cloud usage.

In one embodiment, the techniques described herein are quite effective against Zipfian distributions but without assuming any knowledge on the actual distribution of object popularity and provide solutions for near-optimal load balancing and cache scaling that guarantees low delay with minimum cost. Thus, the techniques provide robust delay performance to users and have high prospective value for customer satisfaction for companies that provide cloud storage services.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### Overview of One Embodiment of a Storage Architecture

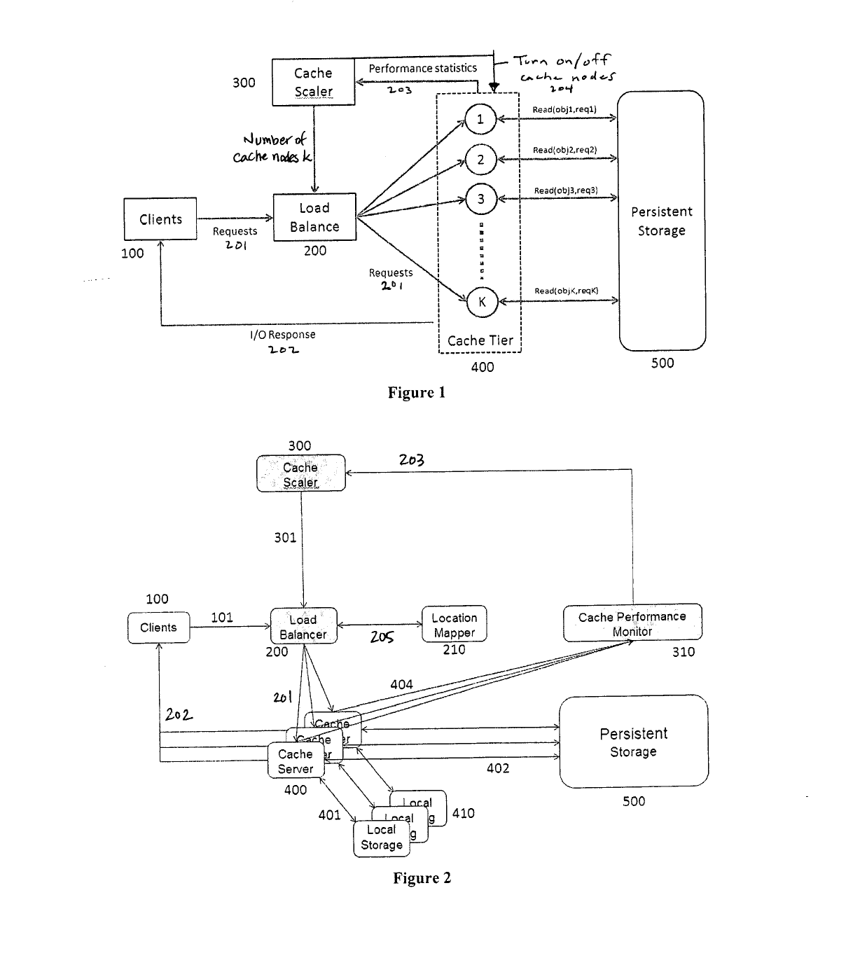

FIG. 1 is a block diagram of one embodiment of a system architecture for a two-tier storage system. FIG. 2 is a block diagram illustrating an application for performing storage in one embodiment of a two-tier storage system.

Referring to FIGS. 1 and 2, clients 100 issue their input/output (I/O) requests 201 (e.g., download(filex)) for data objects (e.g., files) to a load balancer (LB) 200. LB 200 maintains a set of cache nodes that compose a caching tier 400. In one embodiment, the set of caching nodes comprises a set of servers §={1, . . . , K} and LB 200 can direct client requests 201 to any of these cache servers. Each of the cache services includes or has access to local storage, such as local storage 410 of FIG. 2. In one embodiment, caching tier 400 comprises Amazon EC2 or other leased storage resources.

In one embodiment, LB 200 uses a location mapper (e.g,. location mapper 210 of FIG. 2) to keep track of which cache server of cache tier 400 has which object. Using this information, when a client of clients 100 requests a particular object, LB 200 knows which server(s) contains the object and routes the request to one of such cache servers.

In one embodiment, requests 201 sent to the cache nodes from LB 200 specify the object and the client of clients 100 that requested the object. For purposed herein, the total load is denoted as λᵢₙ. Each server j receives a load of λⱼ from LB 200, i.e., λ_{in=Σ}_{jε§}λⱼ. If the cache server has the requested object cached, it provides it to the requesting client of clients 100 via I/O response 202. If the cache server does not have the requested object cached, then it sends a read request (e.g., read(obj1, req1)) specifying the object and its associated request to persistent storage 500. In one embodiment, persistent storage 500 comprises Amazon S3 or another set of leased storage resources. In response to the request, persistent storage 500 provides the requested object to the requesting cache server, which provides it to the client requesting the object via I/O response 202.

In one embodiment, a cache server includes a first input, first output (FIFO) request queue and a set of worker threads. The requests are buffered in the request queue. In another embodiment, the request queue operates as a priority queue, in which requests with lower delay requirement are given strict priority and placed at the head of the request queue. In one embodiment, each cache server is modeled as a FIFO queue followed by L_{c} parallel cache threads. After a read request becomes Head-of-Line (HoL), it is assigned to a first cache thread that becomes available. The HoL request is removed from the request queue and transferred to the one of the worker threads. In one embodiment, the cache server determines when to remove a request from request queue. In one embodiment, the cache server removes a request from request queue when at least one worker thread is idle. If there is a cache hit (i.e., the cache server has the requested file in its local cache), then the cache server serves the requested object back to the original client directly from its local storage at rate μₕ. If there is a cache miss (i.e., the cache server does not have the requested file in its local cache), the cache server first issues a read request for the object to backend persistent storage 500. As soon as the requested object is downloaded to the cache server, the cache server serves it to the client at rate μₕ.

For purposes herein, the cache hit ratio at server j is denoted as p_{h,j} and cache miss ratio as p_{m,j} (i.e., p_{m,j}=1−p_{h,j}). Each server j generates a load of λⱼ×p_{m,j} for the backend persistent storage. In one embodiment, persistent storage 500 is modeled as one large FIFO queue followed by Lₛ parallel storage threads. The arrival rate to the storage is Σ_{jε§}λⱼp_{m,j} and service rate of each individual storage thread is μₘ. In one embodiment, μₘ is significantly less than μₕ, is not controllable by the service provider, and is subject to change over time.

In another embodiment, the cache server employs cut-through routing and feeds the partial reads of an object to the client of clients 100 that is requesting that object as it receives the remaining parts from backend persistent storage 500.

The request routing decisions made by LB 200 ultimately determine which objects are cached, where objects are cached, and how long once the caching policy at cache servers is fixed. For example, if LB 200 issues distinct requests for the same object to multiple servers, the requested object is replicated in those cache servers. Thus, the load for the replicated file can be shared by multiple cache servers. This can be used to avoid the creation of a hot spot.

In one embodiment, each cache server manages the contents of its local cache independently. Therefore, there is no communication that needs to occur between the cache servers. In one embodiment, each cache server in cache tier 400 employs a local cache eviction policy (e.g., Least Recently Used (LRU) policy, Least Frequently Used (LFU) policy, etc.) using only its local access pattern and cache size.

Cache scaler (CS) 300, through cache performance monitor (CPM) 310 of FIG. 2, collects performance statistics 203, such as, for example, backlogs, delay performance, and/or hit ratios, etc. periodically (e.g., every T seconds) from individual cache nodes (e.g., servers) in cache tier 400. Based on performance statistics 203, CS 300 determines whether to add more cache servers of set § or remove some of the existing cache servers of set §. CS 300 notifies LB 200 whenever the set § is altered.

In one embodiment, each cache node has a lease term (e.g., one hour). Thus, the actual server termination occurs in a delayed fashion. If CS 300 scales down the number of servers in set § and then decides to scale up the number of servers in set § again before the termination of some servers, it can cancel the termination decision. Alternatively, if new servers are added to set § followed by a scale down decision, the service provider unnecessarily pays for unused compute-hours. In one embodiment, the lease time Tₗₑₐₛₑ is assumed to be an integer multiple of T.

In one embodiment, all components except for cache tier 400 and persistent storage 500 run on the same physical machine. An example of such a physical machine is described in more detail below. In another embodiment, one or more of these components can be run on different physical machines and communicate with each other. In one embodiment, such communications occur over a network. Such communications may be via wires or wirelessly.

In one embodiment, each cache server is homogeneous, i.e., it has the same CPU, memory size, disk size, network I/O speed, service level agreement.

Embodiments of the Load Balancer

As stated above, LB 200 redirects client requests to individual cache servers (nodes). In one embodiment, LB 200 knows what each cache server's cache content is because it tracks the sequence of requests it forwards to the cache servers. At times, LB 200 routes requests for the same object to multiple cache servers, thereby causing the object to be replicated in those cache servers. This is because one of the cache servers caching the object (which LB 200 knows because it tracks the requests) and at least one cache server doesn't have the object and will have to download or otherwise obtain the object from persistent storage 500. In this way, the request redirecting decisions of the load balancer dictates how each cache server's cache content changes over time.

In one embodiment, given a set § of cache servers, the load balancer (LB) has two objectives:

1) maximize the total cache hit ratio, i.e., minimize the load imposed to the storage Σ_{jε§}λⱼp_{m,j}, so that the extra delay for fetching uncached objects from the persistent storage is minimized; and

2) balance the system utilization across cache servers, so that cases where a small number of servers caching the very popular objects get overloaded while the other servers are under-utilized is avoided.

These two objectives can potentially conflict with each, especially when the distribution of the popularity of requested objects has substantial skewness. One way to mitigate a problem of imbalanced loads is to replicate the very popular objects at multiple cache servers and distribute requests for these objects evenly across these servers. However, while having a better chance of balancing workload across cache servers, doing so reduces the number of distinct objects that can be cached and lowers the overall hit ratio as a result. Therefore, if too many objects are replicated for too many times, such an approach may suffer high delay because too many requests have to served from the much slower backend storage.

In one embodiment, the load balancer uses the popularity of requested files to control load balancing decisions. More specifically, the load balancer estimates the popularity of the requested files and then uses those estimates to decide whether to increase the replication of those files in the cache tier of the storage system. That is, if the load balancer observes that a file is very popular, it can increase the number of replicas of the file. In one embodiment, estimating the popularity of requested files is performed using a global least recently used (LRU) table in which the last requested object becomes the top of the ranked objects in the list during its use. In one embodiment, the load balancer increases the number of replicas by sending a request for the file to a cache server that doesn't have the file cached, thereby forcing the cache server to download the file from the persistent storage and thereafter cache it.

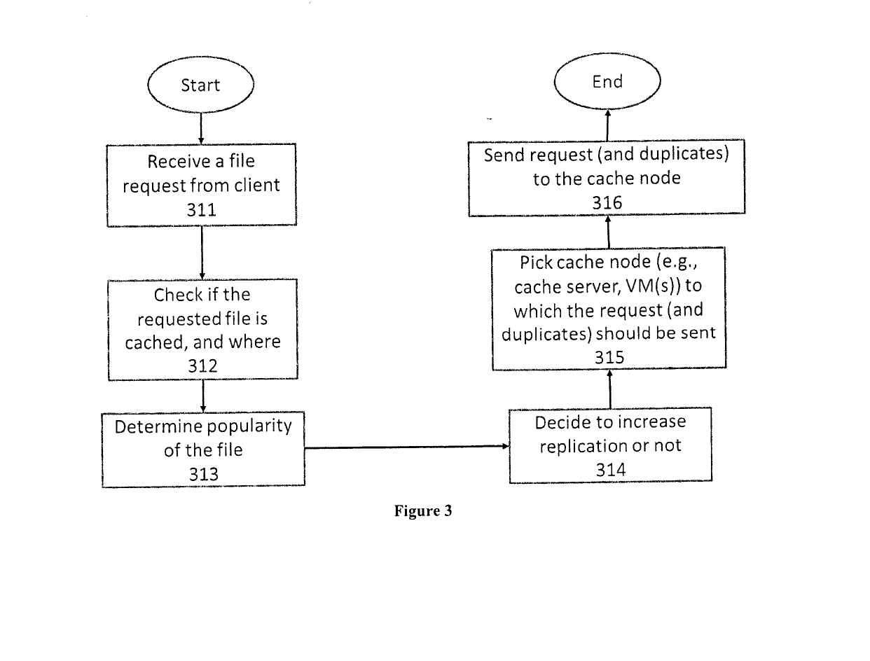

FIG. 3 is a flow diagram of one embodiment of a load balancing process. The process is performed by processing logic that may comprise hardware (circuitry, dedicated logic, etc.), software (such as is run on a general purpose computer system or a dedicated machine), or a combination of both. In one embodiment, the load balancing process is performed by a load balancer, such as LB 200 of FIG. 1.

Referring to FIG. 3, the process begins with processing logic receiving a file request from a client (processing block 311). In response to the file request, processing logic checks whether the requested file is cached and, if so, where the file is cached (processing block 312).

Next, processing logic determines the popularity of the file (processing block 313) and determines whether to increase the replication of the file or not (processing block 314). Processing logic selects the cache node(s) (e.g., cache server, VM, etc.) to which the request and the duplicates, if any, should be sent (processing block 315) and sends the request to that cache node and to the cache node(s) where the duplicates are to be cached (processing block 316). In the case of caching one or more duplicates of the file, if the load balancer sends the request to a cache node that does not already have the file cached, then the cache node will obtain a copy of the file from persistent storage (e.g., persistent storage 500 of FIG. 1), thereby creating a duplicate if another cache node already has a copy of the file. Thereafter, the process ends.

One key benefit of some load balancer embodiments described herein is that any cache server becomes equally important as soon after it is added into the system and once they become equally important, any of them can be shut down as well. This simplifies the scale up/down decisions because the determination of the number of cache servers to use can be made independently of their content and decisions of which cache server(s) to turn off may be made based on which have the closest lease expiration times. Otherwise, if the system decides to add more cache servers, the system can quickly start picking up their fair share of the load according to the overall system objective.

In this manner, the load balancer achieves two goals, namely having a more even distribution of load across servers and keeping the total cache hit ratio close to the maximum, without any knowledge on object popularity, arrival processes and service distributions.

### A. Off-Line Centralized Solution

In one embodiment, a centralized replication solution that assumes a priori knowledge of the popularity of different objects is used. The solution caches the most popular objects and replicates only the top few of them. Thus, its total cache hit ratio remains close to the maximum. Without loss of generality, assume objects are indexed in descending order of popularity. For each object i, rᵢ denotes the number of cache servers assigned to store it. The value of rᵢ and the corresponding set of cache servers are determined off-line based on the relative ranking of popularity of different objects. The heuristic iterates through i=1, 2, 3, . . . and in each iteration,

$${r}_{i} = ⌈ \frac{R}{i} ⌉$$

cache servers are assigned to store copies of object i. In one embodiment, R≦K is the pre-determined maximum number of copies an object can have. In the i-th iteration, a cache server is available if it has been assigned<C objects in the previous i-1 iterations (for objects 1 through i-1). For each available cache server, the sum popularity of objects it has been assigned in the previous iterations is computed initially, and then the

$$⌈ \frac{R}{i} ⌉$$

available servers with the least sum object popularity are selected to store object i. The iterative process continues until there is no cache server available or all objects have been assigned to some server(s). In this centralized heuristic, each cache server only caches objects that have been assigned to it. Thus, in one embodiment, a request for a cached object is directed to one of the corresponding cache servers selected uniformly at random, while a request for an uncached object is directed to a uniformly randomly chosen server, which will serve the object from the persistent storage, but will not cache it. Notice that when the popularity of objects follows a classic Zipf distribution (Zipf exponent=1), the number of copies of each object becomes proportional to its popularity.

### B. Online Solution

In another embodiment, the storage system uses an online probabilistic replication heuristic that requires no prior knowledge of the popularity distribution, and each cache server employs a LRU algorithm as its local cache replacement policy. Since it is assumed that there is no knowledge of the popularity distribution, in addition to the local LRU lists maintained by individual cache servers, the load balancer maintains a global LRU list, which stores the index of unique objects that have been sorted by their last access times from clients, to estimate the relative popularity ranking of the objects. The top (one end) of the list stores the index of the most recently requested object, and bottom (the other end) of the list stores the index for the least recently requested object.

The online heuristic is designed based on the observations that (1) objects with higher popularity should have a higher degree of replication (more copies), and (2) objects that often appear at the top of the global LRU list are likely to be more popular than those stay at the bottom.

In a first, BASIC embodiment of the online heuristic, when a read request for object i arrives, the load balancer first checks whether i is cached or not. If it is not cached, the request is directed to a randomly picked cache server, causing the object to be cached there. If object i is already cached by all K servers in §, the request is directed to a randomly picked cache server. If object i is already cached by rᵢ servers in §ᵢ (1≦rᵢ<K), the load balancer further checks whether i is ranked top M in the global LRU list. If YES, it is considered very popular and the load balancer probabilistically increment rᵢ by one as follows. With probability 1/(rᵢ+1), the request is directed to one randomly selected cache server that is not in §ᵢ, hence rᵢ will be increased by one. Otherwise (with probability rᵢ/(rᵢ+1)), the request is directed to one of the servers in §ᵢ. Hence, rᵢ remains unchanged. On the other hand, if object i is not in the top M entries of the global LRU list, it is considered not sufficiently popular. In such a case, the request is directed to one of the servers in §ᵢ, thus rᵢ is not changed. In doing so, the growth of rᵢ slows down as it gets larger. This design choice helps prevent creating too many unnecessary copies of less popular objects.

In an alternative embodiment, a second, SELECTIVE version of the online heuristic is used. The SELECTIVE version differs from the BASIC in how requests for uncached object are treated. In SELECTIVE, the load balancer checks if the object ranks below a threshold LRU_{threshold}≧M in the global LRU list. If YES, the object is considered very unpopular, and the caching of which will likely cause some more popular objects to be evicted. In this case, when directing the request to a cache node (e.g., cache server), the load balancer attaches a “CACHE CONSCIOUSLY” flag to it. Upon receiving a request with such a flag attached, the cache node serves the object from the persistent storage to the client as usual, but it will cache the object only if its local storage is not full. Such a selective caching mechanism will not prevent increasing rᵢ if an originally unpopular object i suddenly becomes popular, since once the object becomes popular, its ranking will then stay above LRU_{threshold}, due to the responsiveness of the global LRU list.

### Cache Scaler Embodiments

In one embodiment, the cache scaler determines the number of cache servers, or nodes, that are needed. In one embodiment, the cache scaler makes the determination for each upcoming time period. The cache scalar collects statistics from the cache servers and uses the statistics to make the determination. Once the cache scaler determines the desired number of cache servers, the cache scaler turns cache servers on and/or off to meet the desired number. To that end, the cache scaler also determines which cache server(s) to turn off if the number is to be reduced. This determination may be based on expiring lease times associated with the storage resources being used.

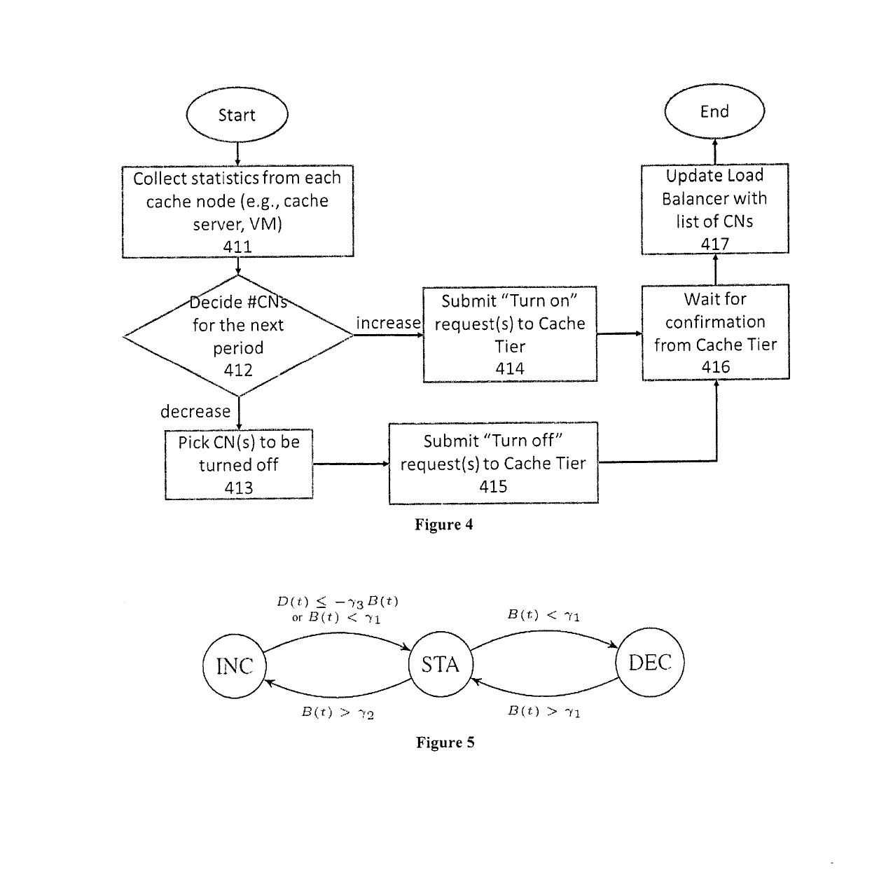

FIG. 4 is a flow diagram of one embodiment of a cache scaling process. The process is performed by processing logic that may comprise hardware (circuitry, dedicated logic, etc.), software (such as is run on a general purpose computer system or a dedicated machine), or a combination of both.

Referring to FIG. 4, the process begins with processing logic collecting statistics from each cache node (e.g., cache server, virtual machine (VM), etc.) (processing block 411). In one embodiment, the cache scaler uses the request backlogs in the caching tier to dynamically adjust the number of active cache servers.

Using the statistics, processing logic determines the number of cache nodes for the next period of time (processing block 412). If processing logic determines to increase the number of cache nodes, then the process transitions to processing block 414 where processing logic submits a “turn on” request to the cache tier. If processing logic determines to decrease the number of cache nodes, then the process transitions to processing block 413 where processing logic selects the cache node(s) to turn off and submits a “turn off” request to the cache tier (processing block 415). In one embodiment, the cache node whose current lease term will expires first is selected. There are other ways to select which cache node to turn off (e.g., the last cache node to be turned on).

After submitting “turn off” or “turn on” requests to the cache tier, the process transitions to processing block 416 where processing logic waits for confirmation from the cache tier. Once confirmation has been received, processing logic updates the load balancer with the list of cache nodes that are in use (processing block 417) and the process ends.

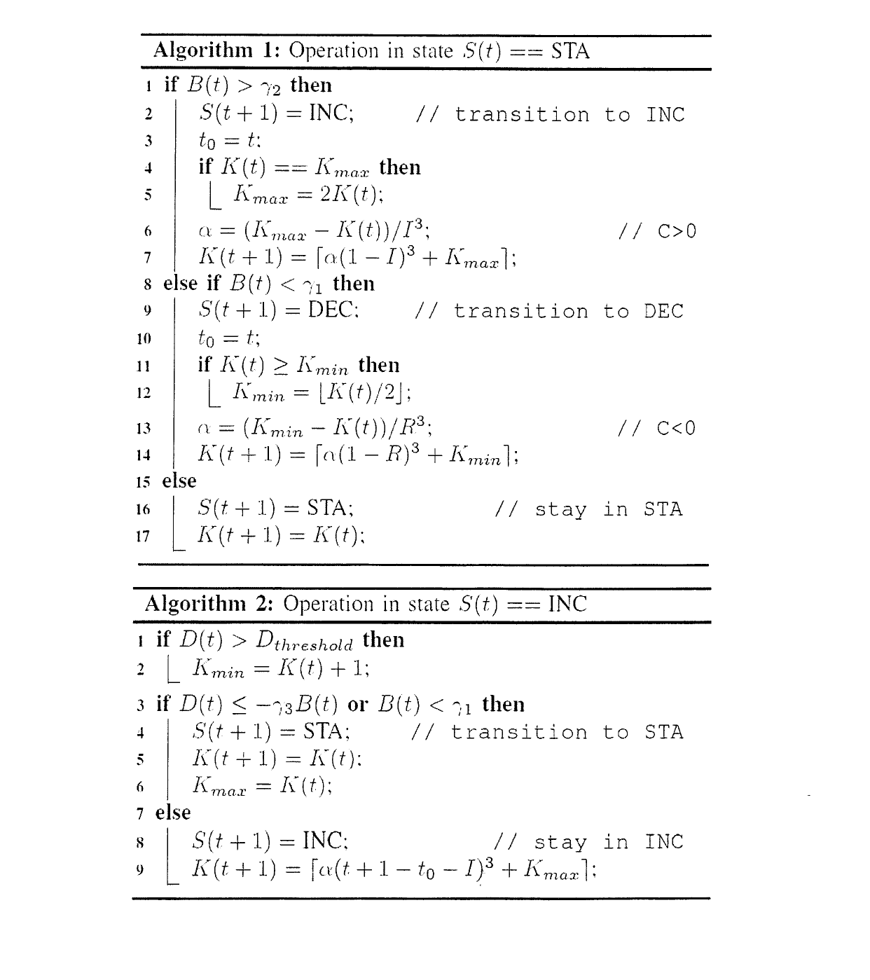

FIG. 5 illustrates one embodiment of a state machine to implement cache scaling based on request backlogs. Referring to FIG. 5, the state machine includes three states:

INC—to increase the number of active servers,

STA—to stabilize the number of active servers, and

DEC—to decrease the number of active servers.

In one embodiment, the scaling operates in a time-slotted fashion: time is divided into epochs of equal size, say T seconds (e.g., 300 seconds) and the state transitions only occur at epoch boundaries. Within an epoch, the number of active cache nodes stays fixed. Individual cache nodes collect time-averaged state information such as, for example, backlogs, delay performance, and hit ratio, etc. throughout the epoch. In one embodiment, the delay performance is the delay for serving a client request, which is the time from when the request is received until the time the client gets the data. If the data is cached, the delay will be the time for transferring it from the cache node to the client. If it is not cached, the time for downloading the data from the persistent storage to the cache node will be added. By the end of the current epoch, the cache scaler collects the information from the cache nodes and determines whether to stay in the current state or to transition into a new state in FIG. 5 in the upcoming epoch. The number of active cache nodes to be used in the next epoch is then determined accordingly.

S(t) and K(t) are used to denote the state and the number of active cache nodes in epoch t, respectively. Let Bᵢ(t) be the time-averaged queue length of cache node i in epoch t, which is the average of sampled queue length taken every 6 time within the epoch. Then the average per-node backlog of epoch t is denoted by B(t)=ΣᵢBᵢ(t)/K(t).

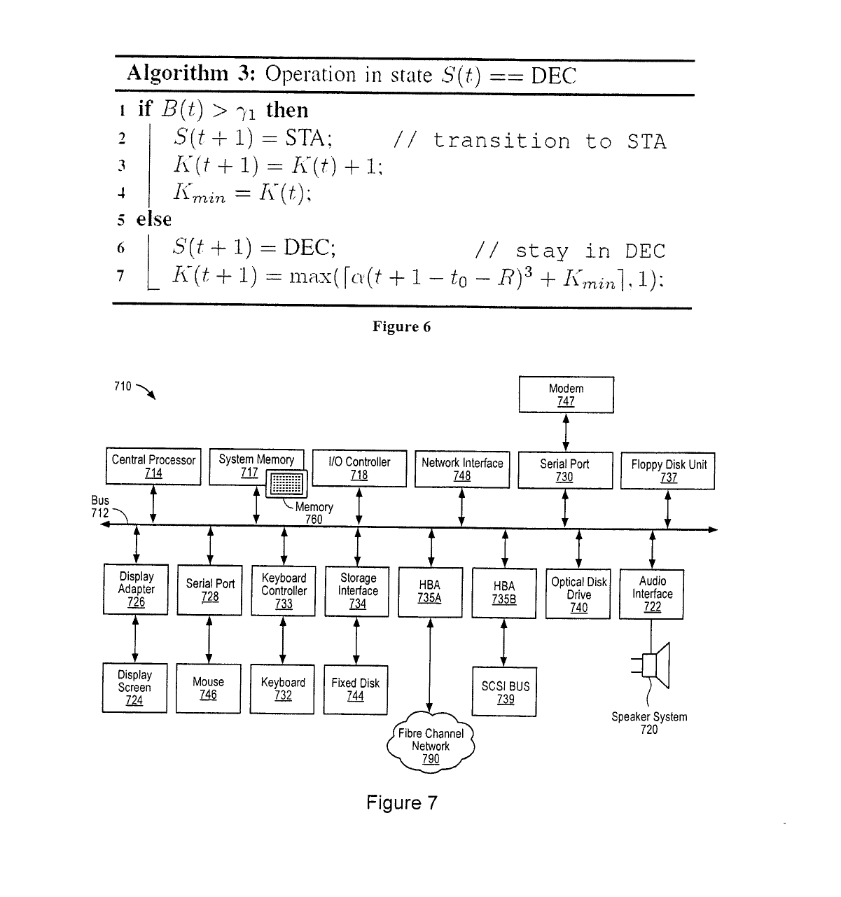

At run-time, the cache scaler maintains two estimates for (1) Kₘᵢₙ—the minimum number of cache nodes needed to avoid backlog build-up for low delay; and (2) Kₘₐₓ—the maximum number of caches nodes going beyond which the delay improvements are negligible. In states DEC (or INC), the heuristic gradually adjusts K(t) towards Kₘᵢₙ (or Kₘₐₓ). As soon as the average backlog B(t) falls in a desired range, it transitions to the STA state, in which K(t) stabilizes. FIG. 6 illustrates algorithms 1, 2 and 3 containing the pseudo-codes for one embodiment of the adaptation operations in state STA, INC and DEC, respectively.

### A. STA State—Stabilizing K

STA is the state in which the storage system should stay most of the time in which K(t) is kept fixed, as long as the per-cache backlog B(t) stays within the pre-determined targeted range (γ1, γ2). If in epoch t₀ with K(t₀) active cache nodes, B(t₀) becomes larger than γ2, and the backlog is considered too large for the desired delay performance. In this situation, the cache scaler transitions into state INC in which K(t) will be increased with the targeted value Kₘₐₓ. On the other hand, if B(t₀) becomes smaller than γ1, the cache nodes are considered to be under-utilized and the system resources are wasted. In this case, the cache scaler transitions into state DEC in which K(t) will be decreased towards Kₘᵢₙ. According to the way Kₘₐₓ is maintained, it is possible that K(t₀)=Kₘₐₓ when the transition from STA to INC occurs and Equation 1 below becomes a constant K(t₀). In this case, Kₘₐₓ is updated to 2K(t₀) in Line 5 in Algorithm 1 to ensure K(t) will indeed be increased.

### B. INC State—Increasing K

While in state INC, the number of active caches nodes (e.g., cache servers, VMs, etc.) are incremented. In one embodiment, the number of active cache nodes is incremented according to a cubic growth function

K(t)=┌α(t−t₀−I)³+Kₘₐₓ┐, (1)

where α=(Kₘₐₓ−K(t₀))/I³>0 and t₀ is the most recent epoch in state STA. I≧1 is the number of epochs that the above function takes to increase K from K(t₀) to Kₘₐₓ. Using equation 1, the number of active cache nodes grows very fast upon a transition from STA to INC, but as it gets closer to Kₘₐₓ, it slows down the growth. Around Kₘₐₓ, the increment becomes almost zero. Above that, the cache scaler starts probing for more cache nodes in which K(t) grows slowly initially, accelerating its growth as it moves away from Kₘₐₓ. This slow growth around Kₘₐₓ enhances the stability of the adaptation, while the fast growth away from Kₘₐₓ ensures the sufficient number of cache nodes will be activated quickly if queue backlog becomes large.

While K(t) is being increased, the cache scaler monitors the drift of backlog D(t) =B(t)−B(t−1) as well. A large D(t)>0 means that the backlog has increased significantly in the current epoch. This implies that K(t) is smaller than the minimum number of active caches nodes needed to support the current workload. Therefore, in Line 2 of Algorithm 2, Kₘᵢₙ is updated to K(t)+1 if D(t) is greater than a predetermined threshold D_{threshold}≧0. Since Equation 1 is a strictly increasing function, eventually K(t) will become larger than the minimum number needed. When this happens, the drift becomes negative and the backlog starts to reduce. However, it is undesirable to stop increasing K(t) as soon as the drift becomes negative since doing so will quite likely end up with a small negative drift and it will take a long time to reduce the already built-up backlog back to the desired range. Therefore, in Algorithm 2, the cache scaler will only transition to STA state if (1) it observes a large negative drift D(t)<−γ3B(t) that will clean up the current backlog within 1/γ3≦1 epochs or (2) the backlog B(t) is back to the desired range<γ1. When this transition occurs, Kₘₐₓ is updated to the last K(t) used in INC state.

### C. DEC State—Decreasing K

The operations for DEC state is similar to those in INC, in the opposite direction. In one embodiment, K(t) is adjusted according to a cubic reduce function

K(t)=max(┌α(t−t₀−R)³+Kₘᵢₙ┐, 1) (2)

with α=(Kₘᵢₙ−K(t₀))/R³<0 and t₀ is the most recent epoch in state STA. R≧1 is the number of epochs it will take to reduced K to Kₘᵢₙ. In one embodiment, K(t) is lower bounded by 1 since there should always be at least one cache node serving requests. As K(t) decreases, the utilization level and backlog of each cache node increases. As soon as the backlog rises back to the desired range>γ1, the cache scaler stops reducing K, switch to STA state and update Kₘᵢₙ to K(t). In one embodiment, when such transition occurs, K(t+1) is set equal to K(t)+1 to prevent the cache scaler from deciding to unnecessarily switch back to DEC in the upcoming epochs due to minor fluctuation in B.

### An Example of a Computer System

FIG. 7 depicts a block diagram of a computer system to implement one or more of the components of FIGS. 1 and 2. Referring to FIG. 7, computer system 710 includes a bus 712 to interconnect subsystems of computer system 710, such as a processor 714, a system memory 717 (e.g., RAM, ROM, etc.), an input/output (I/O) controller 718, an external device, such as a display screen 724 via display adapter 726, serial ports 727 and 730, a keyboard 732 (interfaced with a keyboard controller 733), a storage interface 734, a floppy disk drive 737 operative to receive a floppy disk 737, a host bus adapter (HBA) interface card 735A operative to connect with a Fibre Channel network 790, a host bus adapter (HBA) interface card 735B operative to connect to a SCSI bus 739, and an optical disk drive 740. Also included are a mouse 746 (or other point-and-click device, coupled to bus 712 via serial port 727), a modem 747 (coupled to bus 712 via serial port 730), and a network interface 748 (coupled directly to bus 712).

Bus 712 allows data communication between central processor 714 and system memory 717. System memory 717 (e.g., RAM) may be generally the main memory into which the operating system and application programs are loaded. The ROM or flash memory can contain, among other code, the Basic Input-Output system (BIOS) which controls basic hardware operation such as the interaction with peripheral components. Applications resident with computer system 710 are generally stored on and accessed via a computer readable medium, such as a hard disk drive (e.g., fixed disk 744), an optical drive (e.g., optical drive 740), a floppy disk unit 737, or other storage medium.

Storage interface 734, as with the other storage interfaces of computer system 710, can connect to a standard computer readable medium for storage and/or retrieval of information, such as a fixed disk drive 744. Fixed disk drive 744 may be a part of computer system 710 or may be separate and accessed through other interface systems.

Modem 747 may provide a direct connection to a remote server via a telephone link or to the Internet via an internet service provider (ISP) (e.g., cache servers of FIG. 1). Network interface 748 may provide a direct connection to a remote server such as, for example, cache servers in cache tier 400 of FIG. 1. Network interface 748 may provide a direct connection to a remote server (e.g., a cache server of FIG. 1) via a direct network link to the Internet via a POP (point of presence). Network interface 748 may provide such connection using wireless techniques, including digital cellular telephone connection, a packet connection, digital satellite data connection or the like.

Many other devices or subsystems (not shown) may be connected in a similar manner (e.g., document scanners, digital cameras and so on). Conversely, all of the devices shown in FIG. 7 need not be present to practice the techniques described herein. The devices and subsystems can be interconnected in different ways from that shown in FIG. 7. The operation of a computer system such as that shown in FIG. 7 is readily known in the art and is not discussed in detail in this application.

Code to implement the computer system operations described herein can be stored in computer-readable storage media such as one or more of system memory 717, fixed disk 744, optical disk 742, or floppy disk 737. The operating system provided on computer system 710 may be MS-DOS®, MS-WINDOWS®, OS/2®, UNIX®, Linux®, or another known operating system.

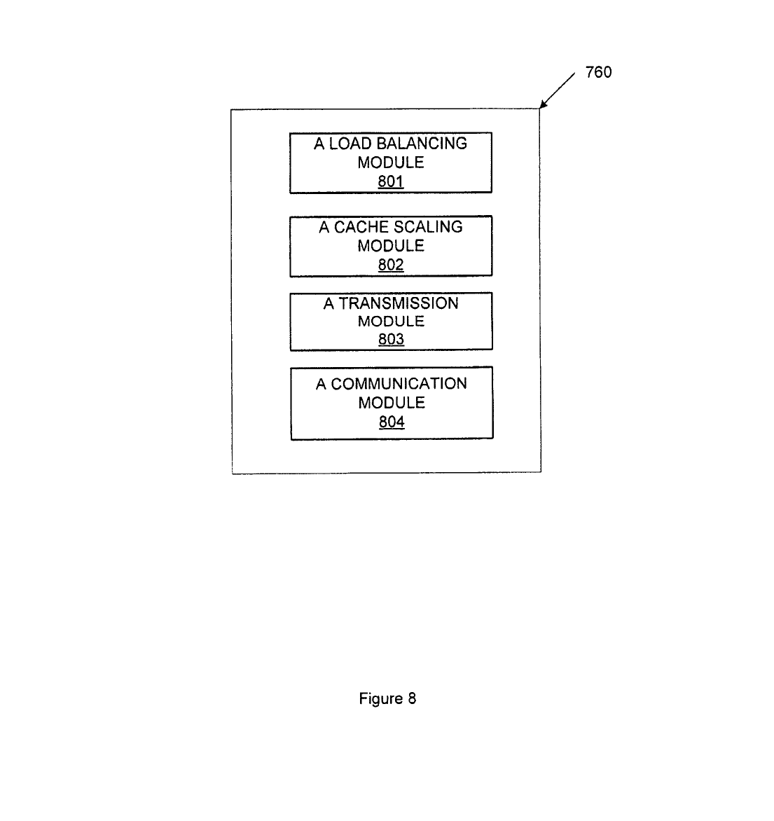

FIG. 8 illustrates a set of code (e.g., programs) and data that is stored in memory of one embodiment of a computer system, such as the computer system set forth in FIG. 7. The computer system uses the code, in conjunction with a processor, to implement the necessary operations (e.g., logic operations) to implement the described herein.

Referring to FIG. 8, the memory 860 includes a load balancing module 801 which when executed by a processor is responsible for performing load balancing as described above. The memory also stores a cache scaling module 802 which, when executed by a processor, is responsible for performing cache scaling operations described above. Memory 860 also stores a transmission module 803, which when executed by a processor causes a data to be sent to the cache tier and clients using, for example, network communications. The memory also includes a communication module 804 used for performing communication (e.g., network communication) with the other devices (e.g., servers, clients, etc.).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. An apparatus for use in two-tier distributed cache storage system having a first tier comprising a persistent storage and a second tier comprising one or more cache nodes communicably coupled to the persistent storage, the apparatus comprising:
a load balancer to direct read requests for objects, received from one or more clients, to at least one of the one or more cache nodes based on a global ranking of objects, each cache node of the at least one cache node serving the object to a requesting client from its local storage in response to a cache hit or downloading the object from the persistent storage and serving the object to the requesting client in response to a cache miss; and
a cache scaler communicably coupled to the load balancer to periodically adjust a number of cache nodes that are active in the cache tier based on performance statistics measured by the one or more cache nodes in the cache tier.

2. The apparatus defined in claim 1 wherein the global ranking is based on a least recently used (LRU) policy.

3. The apparatus defined in claim 1 wherein the load balancer redirects one of the requests for an individual object to a plurality of cache nodes in the at least one cache node to cause the individual object to be replicated in at least one cache node that does not already have the file cached.

4. The apparatus defined in claim 3 wherein the load balancer determines the individual object associated with the one request has a ranking of popularity and redirects the one request for the individual object to the plurality of cache nodes so that the individual object is replicated in the at least one cache node that does not already have the file cached in response to determining the ranking of popularity of the individual object is at the first level.

5. The apparatus defined in claim 1 wherein the load balancer estimates a relative popularity ranking of objects stored in the two-tier storage system using a list.

6. The apparatus defined in claim 5 wherein the list is a global LRU list that stores an indices for the objects such that those indices at one end of the list are associated with objects likely to be more popular than objects associated with those indices at another end of the list.

7. The apparatus defined in claim 5 wherein the load balancer, in response to determining that an individual object is already cached by a first number of cache nodes, checks whether the object is ranked within a top portion in the list and, if so, increments the first number of cache nodes.

8. The apparatus defined in claim 1 wherein the load balancer attaches a flag to one request for one object when redirecting the one request to a cache node that is not currently caching the one object to signal the cache node not to cache the object after obtaining the object from the persistent storage to satisfy the request.

9. The apparatus defined in claim 1 wherein the performance statistics comprise one or more of request backlogs, delay performance information indicative of a delay in serving a client request, and cache hit ratio information.

10. The apparatus defined in claim 1 wherein the cache scaler determines whether to adjust the number of cache nodes based upon a cubic function.

11. The apparatus defined in claim 10 wherein the cache scaler determines a number of cache nodes needed for an up-coming time period, determines whether to turn off or on a cache node to meet the number of cache nodes needed for the up-coming time period, and determines which cache node to turn off if the number of cache nodes for the up-coming time period is to be reduced.

12. The apparatus defined in claim 1 wherein each of the one or more cache nodes employs a local cache eviction policy to manage the set of objects cached in its local storage.

13. The apparatus defined in claim 12 wherein the local cache eviction policy is LRU or Least Frequently Used (LFU).

14. The apparatus defined in claim 1 wherein each cache node of the at least one cache node comprises a cache server or a virtual machine.

15. A method for use in two-tier distributed cache storage system having a first tier comprising a persistent storage and a second tier comprising one or more cache nodes communicably coupled to the persistent storage, the method comprising:
directing read requests for an objects, received by a load balancer from one or more clients, to at least one of the one or more cache nodes based on a global ranking of objects;
each cache node of the at least one cache node serving the object to a requesting client from its local storage in response to a cache hit or downloading the object from the persistent storage and serving the object to the requesting client in response to a cache miss; and
periodically adjusting a number of cache nodes that are active in the cache tier based on performance statistics measured by the one or more cache nodes in the cache tier.

16. The method defined in claim 15 wherein the global ranking is based on a least recently used (LRU) policy.

17. The method defined in claim 15 further comprising redirecting one of the requests for an individual object to a plurality of cache nodes in the at least one cache node to cause the individual object to be replicated in at least one cache node that does not already have the file cached.

18. The method defined in claim 17 further comprising determining the individual object associated with the one request has a ranking of popularity and redirecting the one request for the individual object to the plurality of cache nodes so that the individual object is replicated in the at least one cache node that does not already have the file cached in response to determining the ranking of popularity of the individual object is at the first level.

19. The method defined in claim 15 further comprising estimating a relative popularity ranking of objects stored in the two-tier storage system using a list.

20. The method defined in claim 19 wherein the list is a global LRU list that stores an indices for the objects such that those indices at one end of the list are associated with objects likely to be more popular than objects associated with those indices at another end of the list.

21. The method defined in claim 19 further comprising, in response to determining that an individual object is already cached by a first number of cache nodes, checking whether the object is ranked within a top portion in the list and, if so, incrementing the first number of cache nodes.

22. The method defined in claim 15 further comprising attaching a flag to one request for one object when redirecting the one request to a cache node that is not currently caching the one object to signal the cache node not to cache the object after obtaining the object from the persistent storage to satisfy the request.

23. The method defined in claim 15 wherein the performance statistics comprise one or more of request backlogs, delay performance information indicative of cache delay in responding to requests, and cache hit ratio information.

24. The method defined in claim 15 further comprising determining whether to adjust the number of cache nodes based upon a cubic function.

25. The method defined in claim 24 further comprising determining a number of cache nodes needed for an up-coming time period, determining whether to turn off or on a cache node to meet the number of cache nodes needed for the up-coming time period, and determining which cache node to turn off if the number of cache nodes for the up-coming time period is to be reduced.

26. An article of manufacture having one or more non-transitory storage media storing instructions which, when executed by a two-tier distributed cache storage system having a first tier comprising a persistent storage and a second tier comprising one or more cache nodes communicably coupled to the persistent storage, cause the storage system to perform a method comprising:
directing read requests for an objects, received by a load balancer from one or more clients, to at least one of the one or more cache nodes based on a global ranking of objects;
each cache node of the at least one cache node serving the object to a requesting client from its local storage in response to a cache hit or downloading the object from the persistent storage and serving the object to the requesting client in response to a cache miss; and
periodically adjusting a number of cache nodes that are active in the cache tier based on performance statistics measured by the one or more cache nodes in the cache tier.
